(19) United States
(12) Patent Application Publication
(10) Pub. No.: US 2015/0188185 A1
(43) Pub. Date: Jul. 2, 2015

(54) REINFORCEMENT OF BATTERY

(71) Applicant: Microsoft Corporation, Redmond, WA (US)

(72) Inventors: Joseph Daniel Taylor, Seattle, WA (US); Asa Benjamin Berg, Bellevue, WA (US)

(73) Assignee: Microsoft Corporation, Redmond, WA (US)

(21) Appl. No.: 14/145,796

(22) Filed: Dec. 31, 2013

(51) Int. Cl. H01M 10/04

(52) U.S. Cl. CPC H01M 10/0472

(57) ABSTRACT

Embodiments are disclosed herein that relate to reinforcing batteries. For example, one disclosed embodiment provides a battery, comprising a container, a battery stack arranged within the container in a plurality of layers, each layer of the battery stack comprising an anode structure, a cathode structure, and a separator disposed between the anode structure and the cathode structure, and an adhesive bonding each one or more layers of the battery stack to an adjacent structure.

### BACKGROUND

Batteries, such as rechargeable lithium ion batteries, are used in many types of devices, from handheld devices such as mobile phones to large devices such as automobiles. Batteries include an anode and cathode separated by a separator that prevents the anode and cathode from touching one another, wherein the separator also includes an electrolyte that enables ions to flow through the separator between the anode and cathode materials.

The anode, cathode, and separator may be arranged in various configurations. For example, in some batteries the anode, cathode and separator may be formed as a long sheet-like stack structure, and then rolled into a spiral configuration. The spiral configuration may be cylindrical in shape to fit in a cylindrical container, may be flattened to fit within a thinner container (e.g. a mobile phone battery container), or may be configured to have another shape. In other batteries, the anode/separator/cathode structure may be folded into a zig zag pattern, rather than a spiral pattern, or arranged from physically separate layers.

### SUMMARY

Embodiments are disclosed herein that relate to reinforcing batteries. For example, one disclosed embodiment provides a battery, comprising a container, a battery stack arranged within the container in a plurality of layers, each layer of the battery stack comprising an anode structure, a cathode structure, and a separator disposed between the anode structure and the cathode structure, and an adhesive bonding each one or more layers of the battery stack to an adjacent structure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic sectional view of a multi-layer battery according to an embodiment of the disclosure.

FIG. 2 shows a schematic sectional view of a portion of the battery of FIG. 1, and illustrates example locations for the use of adhesives within the battery.

FIG. 3 shows a schematic plan view of an electrode structure during manufacturing of a battery according to an embodiment of the disclosure, and illustrates an adhesive applied on an electrode support in gaps between active electrode material regions.

FIG. 4 shows a schematic plan view of an electrode structure during manufacturing of a battery according to an embodiment of the disclosure, and illustrates an adhesive applied between a periphery of an electrode support and an active electrode material.

FIG. 5A shows a schematic sectional view of a battery before outgassing according to an embodiment of the disclosure.

FIG. 5B shows a schematic sectional view of a battery after outgassing according to an embodiment of the disclosure.

FIG. 6 shows an embodiment of a battery having a curved configuration according to an embodiment of the disclosure.

FIG. 7 shows an embodiment of a battery having an alternating stacked configuration according to an embodiment of the disclosure.

FIG. 8 shows a flow diagram depicting an example embodiment of a method for making a battery.

FIG. 9 is a schematic block diagram of an example computing device comprising a battery according to the present disclosure.

### DETAILED DESCRIPTION

As mentioned above, the anode, cathode and separator of batteries may be formed as a stack of materials (hereinafter “stack”) on a long sheet and then rolled into a spiral configuration to form multiple layers of the stack. The spiral configuration may be cylindrical in shape to fit in a cylindrical container, may be flattened to fit within a thinner container (e.g. a mobile phone battery container), or may be configured to have any other suitable shape. In other batteries, the stack may be folded into a zig zag pattern, rather than a spiral pattern. In yet other batteries, separate stack units may be arranged in a plurality of layers.

In each of these cases, the arrangement of the stack in a plurality of layers within a container may provide for a compact and power-dense battery. However, such a layered configuration may be susceptible to deformation or damage. For example, dropping a device containing a rolled battery may cause inner layers of the rolled battery to at least partially telescope out from within the more outer layers. Similar problems may be encountered with batteries folded into a zig zag pattern and batteries arranged from physically separate layers.

Some batteries, such as batteries that may be subject to high forces (e.g. batteries for military, consumer electronics, and/or aerospace applications) may be externally reinforced to help avoid such issues. For example, an externally reinforced may be fit within a container sufficiently tight to stop movement of internal battery components. However, achieving such a tight fit may be difficult. For example, after a battery is rolled/folded and then pressed into a rectangular shape, the size of the battery may vary significantly over the course of a production run. In some applications, a length and width of a battery may vary by as much as 1 mm from unit to unit. In light of this size variation, the size of an external reinforcing container may be tailored to fit each individual battery tightly. Such customization of each box for each battery may be expensive and time-consuming in a mass production setting, and may increase the price of an externally reinforced battery compared to an unreinforced battery.

Accordingly, embodiments are disclosed herein that relate to internally reinforcing batteries. Briefly, the disclosed embodiments comprise an adhesive bonding each one or more layers of a battery stack layer to an adjacent structure. The adjacent structure may include, for example, another stack layer, a container for the battery (e.g. a metal canister, polymer pouch, etc.), or other suitable structure. The use of an adhesive in such a manner may help to prevent layers from moving relative to one another when the battery is dropped, jostled, or otherwise quickly accelerated/decelerated, and also may help to prevent the battery from shifting within its container. The disclosed internal reinforcement methods may allow batteries to be efficiently reinforced in a cost-effective manner in a mass production setting. Further, as explained in more detail below, the adhesive may be photo-curable by x-ray radiation, thereby allowing curing to be performed at a late stage in a battery manufacturing process when positioned inside of an opaque container. This may help to avoid damage to the battery during manufacturing, and may allow movement or reworkability of battery parts during manufacturing and prior to curing, as discussed in more detail below.

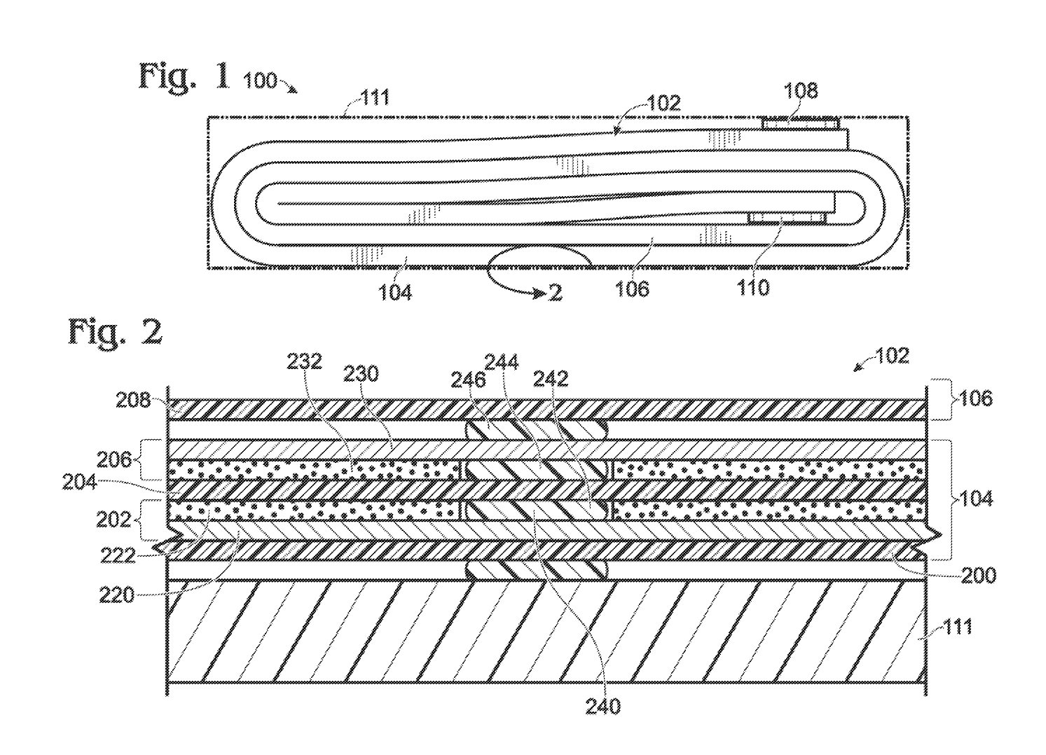

FIG. 1 shows a schematic depiction of a battery 100 having a rolled configuration. The battery 100 comprises a cathode/separator/anode stack 102 arranged into a roll comprising a plurality of layers. Two examples of such layers include outermost layer 104 and next outermost layer 106. The depicted battery 100 comprises a generally flat configuration, e.g. to fit within a planar container, shown schematically at 107, but it will be understood that a rolled battery or other layered battery may have any other suitable configuration. The battery 100 also comprises terminals 108, 110 configured to allow the battery 100 to be connected to a circuit to supply power to the circuit, and a container schematically illustrated at 111.

FIG. 2 shows the construction of an example layer of cathode/separator/anode stack 102 of the battery 100 as taken from cutout 2 of FIG. 1. The stack 102 comprises a first separator layer 200, an anode structure 202, a second separator layer 204, a cathode structure 206, and a third separator layer 208. The first separator layer 200 may helps to insulate layers of the battery from one another when rolled, folded, or otherwise arranged in a stacked formation. In the depicted embodiment the anode structure 202 is shown as being disposed on the first separator layer 200, but in other embodiments the cathode structure 206 may be disposed on the first separator layer 200.

The anode structure 202 includes an anode support 220 and an active anode material 222. The anode support 220 may be formed, for example, from a conductive metal, and also may act as a current collector for receiving electrons from the active anode material 222 during battery use. The cathode structure 206 likewise includes a cathode support 230 and an active cathode material 232, wherein the cathode support 230 may act as a current collector to provide electrons to the active cathode material 232 during battery use. While the active anode material 222 and the active cathode material 232 are each shown as being disposed on a single side of the anode support 220 and cathode support 230 respectively, it will be understood that the active anode material and/or active cathode material may be disposed on both sides of the respective supports in some embodiments. The battery stack 102 may be formed from any suitable materials, depending upon a battery chemistry used by the battery.

As mentioned above, the stack layers of the battery 100 may be susceptible to telescoping or otherwise shifting relative to one another when the battery undergoes sudden acceleration/deceleration, such as when a device utilizing the battery 100 is dropped. Thus, to help prevent damage from such events, the battery 100 may include an adhesive or adhesives bonding one or more of the stack layers to an adjacent structure (e.g. an adjacent stack layer or a container for the battery.

FIG. 2 shows various examples of ways in which an adhesive may be used to bond a battery stack layer to an adjacent layer. For example, FIG. 2 depicts a first example of the use of an adhesive 240 to bond a layer of the stack 102 to an adjacent structure. In this example, the adjacent structure is an inner wall of the container 107, and the layer of the stack is first separator layer 200, which is the outermost surface of the stack in the depicted embodiment. Bonding the outermost surface of the stack 102 to the inner wall of the container 107 may help to avoid displacement of the stack 102 relative to the container 107, and thereby may help prevent damage to the battery 100 when the battery is dropped or undergoes other such shock.

FIG. 2 also shows another example of an adhesive 242 used to bond a layer of the stack 102 to an adjacent structure. In this example, the layer of the stack is the anode support 220, and the adjacent layer is the second separator layer 204 (or any other separator layer in any other battery stack layer). As depicted, the active anode material 222 is not deposited on a region of the anode support 220 on which the adhesive is bonded, thereby allowing the metal anode support to bond directly to the second separator layer 204. FIG. 2 further shows adhesive 244 bonding the cathode support 230 to the second separator layer 204 in a similar manner.

FIG. 2 shows yet another example of an adhesive 246 used to bond the cathode support layer 30 in one layer of the battery stack to an adjacent layer in the form of a separator of a next layer of the battery stack. The use of an adhesive in this location may help to prevent the depicted layers from telescoping relative to one another when dropped, etc. It will be understood that the various uses and placements of adhesives shown in FIG. 2 are depicted for the purpose of example and are not intended to be limiting in any manner, as an adhesive may be used to bond any other suitable battery stack layer or layers to any other suitable adjacent structure than those shown. Further, it will be understood that a battery may have adhesives in any single location or any combination of plural locations in a battery.

An adhesive may be applied to a battery during manufacturing in any suitable manner. For example, in some embodiments the anode active material 222 and cathode active material 232 may be applied as a slurry onto a roll of the respective support material. In such embodiments, regions onto which the active electrode materials are to be deposited may be determined, and those areas may be skipped during the deposition of the active electrode material slurry or slurries. The adhesive may be deposited in those areas either before or after the deposition of the slurry. Likewise, where the adhesive is deposited on an outer surface of the battery, the adhesive may be deposited after the layered battery structure has been formed and prior to insertion of the layered battery structure into a container. It will be understood that an adhesive may be deposited in an automated process that is integrated with an existing battery manufacturing line.

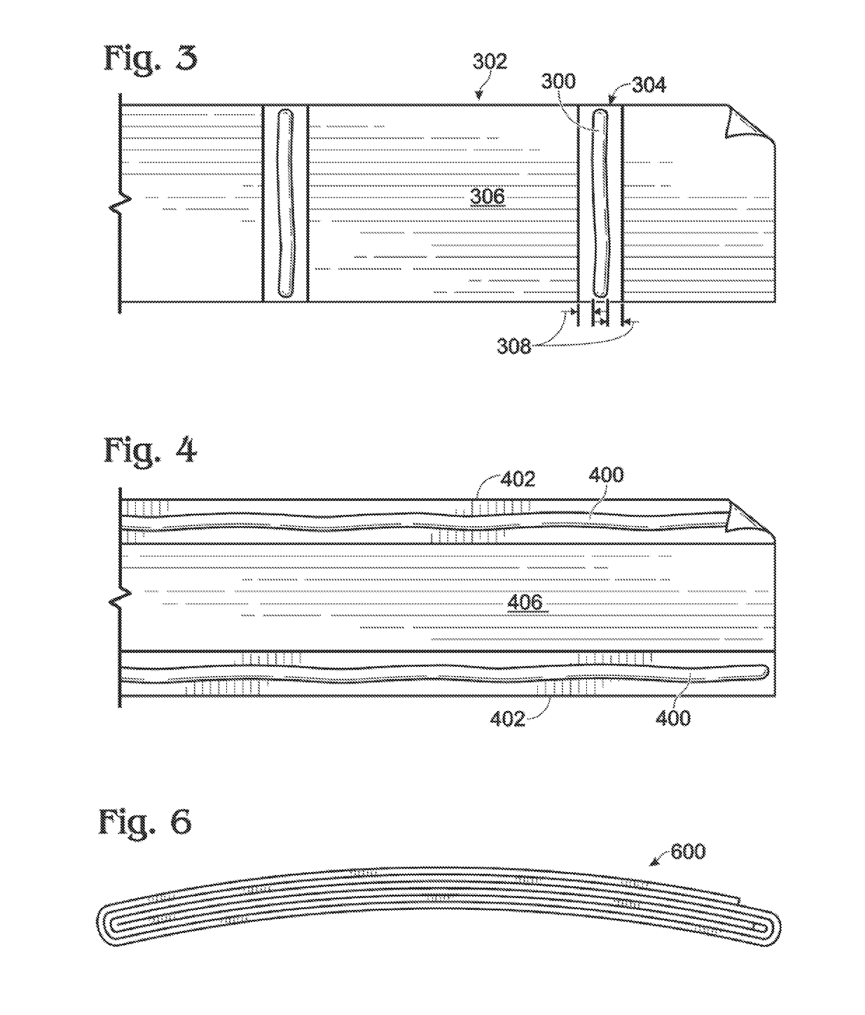

FIGS. 3 and 4 show non-limiting examples of adhesives deposited onto an electrode support (either an anode support or a cathode support). First, FIG. 3 shows a bead of adhesive 300 deposited across a width of an electrode material support 302 at each a location of a gap 304 in the active electrode material 306 (e.g. active anode or active cathode material). Some margin 308 may be provided around the bead to allow for spreading/running when the depicted structure is pressed against an adjacent layer. Likewise, FIG. 4 shows beads of adhesive 400 deposited between a periphery 402 of the electrode support 404 and the active electrode material 406. It will be understood that these examples of placements of adhesive are presented for the purpose of example and are not intended to be limiting in any manner.

The adhesive may be cured in any suitable manner. For example, in some instances it may be desired to cure the adhesive after assembly of the battery is otherwise complete. Curing the adhesive at this point may help to avoid any manufacturing issues that may arise with the use of an adhesive that cures earlier in a manufacturing process, as curing of the adhesive prior to placing a layered battery stack structure into a container, attaching electrode contacts, etc. may cause mechanical stress on the adhered layers as layers encounter various forces during later steps. Further, adhering earlier in a manufacturing process also may complicate repositioning/reworking of battery components during manufacturing.

Thus, the use of an adhesive that is curable via the application of energy, instead of a self-curing adhesive (e.g. a pressure-sensitive adhesive), may help to avoid such issues. Some battery chemistries may be suitable for use with a thermally curable adhesive. However, other battery chemistries (e.g. active electrode materials, electrolytes, separators, etc.) may not be able to withstand the temperatures used for curing such materials. Thus, in some embodiments, a photo-curable adhesive may be used. For example, some adhesives take the form of liquids or gels that may be cured quickly by exposure to ultraviolet (UV) light. Such photo-reactive adhesives may offer distinct advantages relative to other adhesives, including low cure time, high repeatability of application, easy reworkability prior to curing, and high bond strength. Further, many UV curable adhesives are solvent-free, and thus may not outgas appreciably as they cure.

One possible problem UV-cured adhesives is that non-transparent materials may block UV light from reaching the area to be bonded. Thus, in some embodiments, the adhesive may be cured by exposure to x-ray radiation. By curing a photoreactive liquid adhesive with x-ray radiation, photoreactively cured adhesives may be used to bond areas not reachable with UV light due to opaque materials, including but not limited to plastics, metals, ceramics, paints and other materials. As many battery materials, including metals and electrode materials, may not be transparent, x-ray curing may be well suited to curing an adhesive located within an interior of a battery after assembly of the battery, as the high energy photons of x-rays can penetrate opaque materials such as common plastics and metals up to a significant thickness.

Any suitable x-ray radiation may be used to cure an adhesive within a battery. Non-limiting examples include, but are not limited to, x-rays wavelengths ranging from 0.01-10 nanometers, at energies ranging from 100 eV to 100 keV. X-ray radiation may be used to cure both free-radically cured acrylate-based and cationically-cured epoxy based adhesives, as non-limiting examples.

The use of x-ray radiation to cure photo-curable adhesives also may provide additional benefits. For example, some challenges with UV curable adhesives may include slower curing times for cationically cured adhesives relative to radically cured adhesives (e.g. minutes compared to seconds). The use of high energy x-rays instead of UV light may potentially speed up the cure time of epoxy-based cationic adhesives. Another potential problem with UV-curable adhesives may be “skin-over”, where the thin, outermost (closest to the light source) layer of adhesive cures and hardens, blocking some of the UV light and impeding curing of the remainder of the adhesive in the bond area. X-ray radiation offers improved penetration and thus may prevent “skin-over” effects which could impede proper curing of an adhesive within a battery.

As another potential advantage of using x-rays to cure an adhesive in a battery manufacturing process, many battery manufacturing lines may utilize x-ray machines to inspect completed batteries. As such, this existing x-ray inspection equipment within a manufacturing line also may be used to cure an adhesive within the battery. The x-ray intensity emitted by such equipment may be variable. As such, the power level may be varied for the inspection and curing processes. For example, a low power x-ray exposure may be used for inspection, while a higher power x-ray exposure may be used for curing the adhesive, either before or after inspection. Thus, an x-ray curable adhesive may be incorporated into a battery manufacturing process using existing equipment on the production lines.

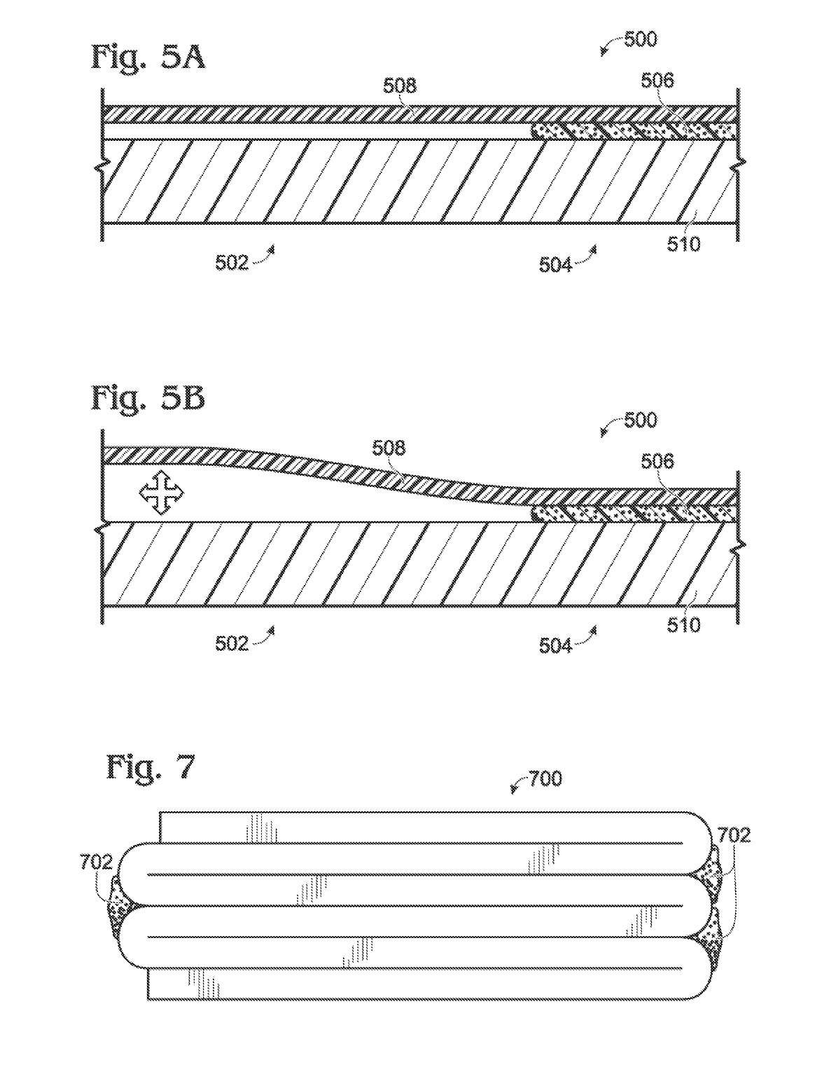

In some embodiments, an adhesive may be positioned to direct volumetric expansion of a battery over its use life to a desired specific region. In this manner, expansion (e.g. due to outgassing over the life of a battery) may be channeled to a region of a device having volume designed to accommodate battery expansion, while other areas of the battery that are not located in such areas of a device may include adhesives configured to resist such expansion. FIGS. 5A and 5B show an example embodiment of a battery 500 having an adhesive configured to direction expansion to a first region 502 and away from a second region 504. In the depicted embodiment, an adhesive 506 is located between a battery stack layer 508 and an outer container 510 in the second region 504, while no adhesive is located between these structures in the first region 502. Thus, as outgassing occurs over time, the battery 500 may expand in volume more easily in the first region 502 than in the second region 504, which may result in a greater degree of expansion occurring in the first region 502. Adhesives between other battery layers may similarly help direct expansion.

While the battery 100 of FIG. 1 has a planar configuration, other embodiments may have different configurations. For example, a device configured to conform to a curve surface (e.g. an armband having electronics) may comprise a curved battery. FIG. 6 shows an example embodiment of a curved battery 600. Unlike a flat battery a curved battery 600 may preferentially expand toward the inside of the curvature of the battery rather than the outside of the curvature. This may cause the curved battery 600 to lose its curvature over time. Thus, to help maintain the curved shape, an adhesive may be used in a curved battery in the manner described above to help prevent layers from separating within the battery and/or to help prevent expansion from flattening the inside of the curvature. This may help the curved battery 600 to maintain its shape as it ages and expands. It will be understood that batteries of any other suitable shape may similarly benefit from the use of an adhesive as described herein.

In the embodiment of FIG. 2, example adhesive placements are shown that are located within an interior of a layered battery structure to help prevent the layers from shifting relative to one another. In other embodiments, an adhesive may be placed at any other suitable location. Further, the location at which an adhesive is placed may be selected based upon the particular structure of a battery. For example, FIG. 7 shows an embodiment of a layered battery structure 700 having a folded configuration in which a battery stack is arranged in a zig-zag configuration. In this configuration, the border between each layer is exposed on an external side of the battery, unlike a rolled battery. Thus, in such an embodiment, an adhesive 702 may be applied at the exposed border between each layer. The depicted adhesive placement also may be used to bond layered battery structure 700 to an inside surface of a container.

The adhesive 702 may comprise a photo-curable adhesive (e.g. x-ray and/or UV curable), a pressure sensitive adhesive, a thermally curable adhesive, a slow curing adhesive, and/or any other suitable adhesive. The use of an x-ray curable adhesive may allow the adhesive to be quickly cured without outgassing of solvents after placing the layered battery structure 700 into an opaque container. An adhesive may be similarly used to bond layers of a battery in which individual battery stack units are arranged in layers (as opposed to a single, long stack being folded or rolled).

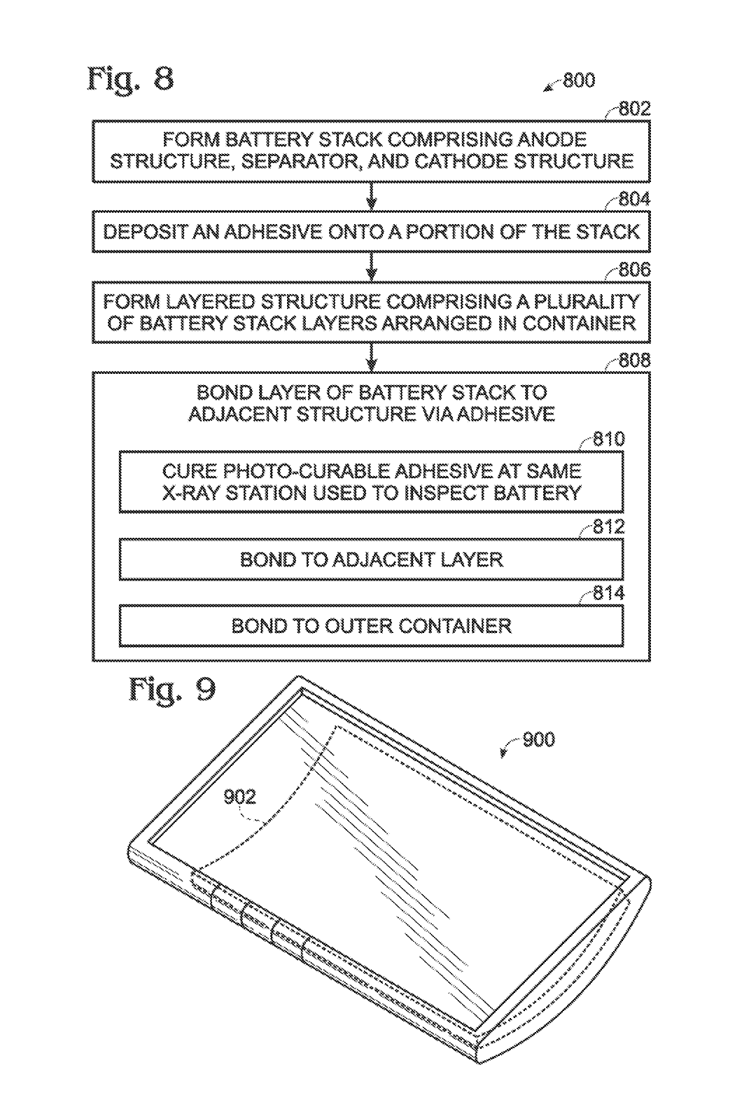

FIG. 8 shows a flow diagram depicting an embodiment of a method 800 for manufacturing a battery. Method 800 comprises, at 802, forming a battery stack comprising an anode structure, a separator, and a cathode structure, and at 804, depositing an adhesive onto a portion of the stack. The adhesive may be deposited in any suitable location, and may be deposited in more than one location. For example, in some embodiments, an adhesive may be deposited on an electrode support (e.g. an anode support and/or a cathode support) at a location corresponding to a gap in an active electrode material. In other embodiments, an adhesive may be provided between a periphery of an electrode support or separator and an active electrode material. Likewise, in some embodiments, an adhesive may be deposited on a separator or other outer layer of a battery stack and be configured to bond to an outer container. In yet other embodiments, an adhesive may be applied to an outer surface of a battery comprising folded or stacked layers to bond the layers together. Any suitable adhesive may be used. Examples include, but are not limited to, photo-curable adhesives (e.g. x-ray curable adhesives, gamma ray curable adhesives, UV curable adhesives, etc.), pressure sensitive adhesives, thermally curable adhesives, slow cure (e.g. self-curing) adhesives, etc. It will be understood that these specific locations of adhesives and adhesive materials are presented for the purpose of example, and are not intended to be limiting in any manner.

Method 800 further comprises, at 806, forming a layered structure comprising a plurality of battery stack layers arranged in a container. The layered structure may have any suitable configuration, including but not limited to a rolled configuration, stacked configuration, folded configuration, etc. Likewise, the layered structure may be placed in any suitable container, including cylindrical, prismatic, and other shaped containers. In various embodiments, the container may be formed from a metal, a polymer pouch, and/or other suitable materials. The layered structure may be formed either before or after the application of the adhesive, depending upon the location of the adhesive, a manufacturing process used, and other such factors.

Method 800 also comprises, at 808, bonding a layer of the battery stack to an adjacent structure via an adhesive, such as a photo-curable adhesive or other suitable adhesive. A photo-curable adhesive may be cured by x-ray radiation, by UV radiation, and/or by any other suitable wavelength of electromagnetic energy. X-ray curing may be used, for example, where an adhesive inside of an opaque structure (e.g. within a battery container, within an interior of a layered battery structure, etc.). Further, as mentioned above, a photo-curable adhesive may be cured at a same x-ray station used to inspect a battery, as indicated at 810. The photo-curing may bond a layer of the battery stack to an adjacent layer 812, to an outer container of the battery 814, and/or to any other suitable adjacent structure.

The curing of the x-ray curable adhesive at a same station used to inspect the battery may be performed in a same step as the inspection, or in a different step than the inspection. For example, x-ray inspection may be performed first using relatively lower power. If the battery passes inspection, x-ray power may be increased to initiate the curing. On the other hand, if the battery does not pass inspection, the battery can be set aside by the inspector to be re-worked by the assembler to fix whatever issue caused the unit to fail first-pass inspection. Because the adhesive remains liquid and “unsticky” until the higher power x-ray is applied, the assembler may have the capability and time window to disassemble and fix the battery, as opposed to the use of a single inspection/curing step, a time-curing adhesive or a pressure-sensitive adhesive. Thus, the use of x-ray inspection and curing at a same station in a two-step process may potentially improve the yield rate of mass production battery manufacture.

In some embodiments, a battery as disclosed herein may be incorporated into another apparatus. Examples include, but are not limited to, computing systems (e.g. laptop computers, tablet computers, home-entertainment computers, network computing devices, gaming devices, mobile computing devices, mobile communication devices (e.g., smart phones), wearable computing devices, and other computing devices; vehicles (e.g. hybrid electric vehicles, electric vehicles, light and heavy industrial vehicles); power supplies (e.g. backup power supplies), and/or any other suitable devices. FIG. 9 shows a non-limiting example in the form of a mobile phone 900, wherein a battery is indicated schematically at 902. As mobile phones may be dropped, the use of an adhesive in the battery 902 as disclosed herein may help to reduce the likelihood of damage such as telescoping or otherwise shifting of battery layers when drops and other such actions occur. This may help to extend the lifetime of a battery. Further, as many devices may have non-removable batteries, this also may help to extend the lifetime of devices having such batteries.

It will be understood that the configurations and/or approaches described herein are presented for the purpose of example, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A battery, comprising:
a container;
a battery stack arranged within the container in a plurality of layers, each layer of the battery stack comprising an anode structure, a cathode structure, and a separator disposed between the anode structure and the cathode structure; and
a photo-curable adhesive bonding each one or more layers of the battery stack to an adjacent structure.

2. The battery of claim 1, wherein the adjacent structure comprises another layer of the battery stack.

3. The battery of claim 2, wherein the photo-curable adhesive bonds the separator to a current collector at a gap in an active material of one or more of the anode structure and the cathode structure.

4. The battery of claim 2, wherein the photo-curable adhesive is disposed between a periphery and an active electrode material of one or more of the anode structure and the cathode structure.

5. The battery of claim 1, wherein the photo-curable adhesive bonds the one or more layers of the battery stack to the container.

6. The battery of claim 5, wherein the photo-curable adhesive bonds the one or more layers of the battery stack to the container in a first region, and not in a second region configured to accommodate expansion from outgassing.

7. The battery of claim 1, wherein the battery comprises adhesive bonding one or more layers of the battery stack to one or more adjacent layers and also bonding an outer layer of the battery stack to the container.

8. The battery of claim 1, wherein the battery stack is arranged in a rolled configuration to form the plurality of layers.

9. The battery of claim 1, wherein the battery stack is arranged in a folded configuration to form the plurality of layers, and wherein the photo-curable adhesive is disposed at a fold of the folded structure.

10. The battery of claim 1, wherein the plurality of layers are arranged in a planar shape.

11. The battery of claim 1, wherein the plurality of layers are arranged in a curved shape.

12. The battery of claim 1, wherein the photo-curable adhesive comprises an x-ray curable adhesive.

13. A method of constructing a battery, the method comprising:
forming a battery stack comprising an anode structure, a separator, and a cathode structure;
depositing an adhesive onto a portion of the battery stack;
forming a layered structure comprising a plurality of battery stack layers arranged in a container; and
bonding a layer of the battery stack to an adjacent structure via the photo-curable adhesive.

14. The method of claim 13, wherein bonding the layer of the battery stack to the adjacent structure comprises curing the photo-curable adhesive via x-ray radiation.

15. The method of claim 14, wherein curing the photo-curable adhesive via x-rays comprises curing the photo-curable adhesive at a same x-ray station used to inspect the battery.

16. The method of claim 13, wherein the photo-curable adhesive bonds the layer of the battery stack to one or more of an adjacent battery stack layer and the container.

17. The method of claim 13, wherein depositing the photo-curable adhesive onto the battery stack comprises depositing the photo-curable adhesive at a location corresponding to a gap in one or more of the anode structure and the cathode structure.

18. The method of claim 13, wherein depositing the photo-curable adhesive onto the battery stack comprises locating the photo-curable adhesive between a periphery of and one or more of the cathode structure and the anode structure.

19. A battery, comprising:
a container;
a battery stack disposed within the container and arranged in a rolled structure comprising a plurality of layers, the battery stack comprising an anode layer, a cathode layer, and a separator disposed between the anode layer and the cathode layer; and
a photo-curable adhesive bonding each of a plurality of layers of the battery stack to an adjacent structures.

20. The battery of claim 19, wherein the photo-curable adhesive comprises an x-ray curable adhesive.
